(19) United States
(12) Patent Application Publication
(10) Pub. No.: US 2026/0134067 A1
(43) Pub. Date: May 14, 2026

(54) METHOD AND APPARATUS WITH MULTIMODAL MODEL FINGERPRINTING

(71) Applicant: Samsung Electronics Co., Ltd., Suwon-si (KR)

(72) Inventors: Kyuhyun SHIM, Suwon-si (KR); Seongeun KIM, Suwon-si (KR); Hyeongseok SON, Suwon-si (KR); Seohyung LEE, Suwon-si (KR); Sangil JUNG, Suwon-si (KR)

(73) Assignee: Samsung Electronics Co., Ltd., Suwon-si (KR)

(21) Appl. No.: 19/197,397

(22) Filed: May 2, 2025

(30) Foreign Application Priority Data
Nov. 12, 2024 (KR) 10-2024-0160378

(51) Int. Cl. G06F 21/16

(52) U.S. Cl. CPC G06F 21/16

(57) ABSTRACT

Disclosed are a fingerprinting method and an apparatus. The fingerprinting method is performed by one or more processors, and includes: generating a fingerprint input set that includes multimodal fingerprint items of multimodal data, each multimodal fingerprint item of multimodal data including a first item of a first data type and a second item of a second data type; obtaining embeddings of respective training data items including the multimodal fingerprint items; and training a target model based on the embeddings.

### CROSS-REFERENCE TO RELATED APPLICATIONS

This application claims the benefit under 35 USC § 119(a) of Korean Patent Application No. 10-2024-0160378, filed on Nov. 12, 2024, in the Korean Intellectual Property Office, the entire disclosure of which is incorporated herein by reference for all purposes.

### BACKGROUND

### 1. Field

The following description relates to a method and an apparatus with fingerprinting.

### 2. Description of Related Art

Recently, machine learning models have been increasingly released as open source, and technology is being used for adding a fingerprint to a model to identify the source of the model, thus preventing illegal use and protecting the ownership of the model. A fingerprint of a model may be implemented mainly through methods such as digital watermarking, uniqueness of data processing methods, parameter tracking, encryption and authentication, and training data watermarking. It would be beneficial to provide model fingerprinting technology able to prevent a malicious user from evading fingerprinting and to safely indicate the source of a model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The following examples may provide fingerprinting technology to prevent a malicious user from finding a fingerprint input.

However, the technical goals are not limited to the foregoing goals, and there may be other technical goals.

In one general aspect, a fingerprinting method is performed by one or more processors, and the method includes: generating a fingerprint input set that includes multimodal fingerprint items of multimodal data, each multimodal fingerprint item of multimodal data including a first item of a first data type and a second item of a second data type; obtaining embeddings of respective training data items including the multimodal fingerprint items; and training a target model based on the embeddings.

The training of the target model may include, based on a loss function, training the target model to output ground truth (GT) items of the respective multimodal fingerprint items of the fingerprint input set based on the fingerprint input set.

The loss function may be based on a difference between output data of the target model corresponding to input data included in the training data and the GT items of the input data included in the training data, the GT items respectively corresponding to the multimodal fingerprint items.

The first data type may be a predetermined image type and the second data type may be a predetermined text type.

The generating of the fingerprint input set may include: obtaining data of the first data type and data of the second data type; and generating the fingerprint input set by combining the data of the first data type and the data of the second data type to form the multimodal fingerprint items.

The fingerprinting method may further include: inputting a test item to a test model which infers therefrom a test output, the test item corresponding to one of the multimodal fingerprint items; determining whether the test model is a derivative of the trained target model by determining whether the test output matches a GT label associated with the one of the fingerprint items.

The embeddings may be obtained based on an encoder configured to encode the multimodal fingerprint items into the embeddings, which are in a single embedding space.

Ground truth (GT) data items of the fingerprint input set may respectively correspond to the multimodal fingerprint items.

The trained target model may be configured to output ground truth (GT) data of the fingerprint input set in response to an input of the fingerprint input set.

The target model may be a multimodal foundation model (MMFM).

A non-transitory computer-readable storage medium may store instructions that, when executed by a processor, cause the processor to perform any of the fingerprinting methods.

In another general aspect, an apparatus includes: one more processors; and a memory storing instructions that when executed by the one or more processors cause the apparatus to perform: generating a fingerprint input set that includes multimodal fingerprint items of multimodal data, each multimodal fingerprint item of multimodal data including a first item of a first data type and a second item of a second data type; obtaining embeddings of respective training data items including the multimodal fingerprint items; and training a target model based on the embeddings.

The training of the target model may include, based on a loss function, training the target model to output ground truth (GT) items of the respective multimodal fingerprint items of the fingerprint input set based on the fingerprint input set.

The loss function may be based on a difference between output data of the target model corresponding to input data included in the training data and the GT items of the input data included in the training data, the GT items respectively corresponding to the multimodal fingerprint items.

The generating of the fingerprint input set may include: obtaining data of the first data type and data of the second data type; and generating the fingerprint input set by combining the data of the first data type and the data of the second data type to form the multimodal fingerprint items.

The embeddings may be obtained based on an encoder configured to encode the multimodal fingerprint items into respective the respective embeddings which are in a single embedding space.

Ground truth (GT) data items of the fingerprint input set may respectively correspond to the multimodal fingerprint items.

The trained target model may be configured to output ground truth (GT) data of the fingerprint input set in response to an input of the fingerprint input set.

In another general aspect, a method of performing model fingerprinting for a first model and a second model is performed by one or more processors and includes: training the first model with a training data set that includes fingerprint training data and non-fingerprint training data, the fingerprint data including multimodal fingerprint items respectively associated with ground truth (GT) labels, each multimodal fingerprint item including a first item of a first data type and a second item of a second data type; the training including inputting the multimodal fingerprint items to an encoder, the encoder encoding the multimodal fingerprint items to respective embedding vectors in a single embedding space, wherein the training is based on a loss between outputs inferred by the first model from the respective embedding vectors and the GT labels; and determining whether the second model is a derivative of the first model by inputting multimodal test items to the second model which infers respective output items therefrom, and determining whether the output items correspond to the GT labels.

The multimodal test items may each include a third item of the first data type and a fourth item of the second data type.

Other features and aspects will be apparent from the following detailed description, the drawings, and the claims.

### BRIEF DESCRIPTION OF THE DRAWINGS

FIG. 1 illustrates an example of a fingerprinting method, according to one or more embodiments.

FIG. 2 illustrates an example of an operation of obtaining training data that includes a fingerprint input set, according to one or more embodiments.

FIG. 3 illustrates an example of a method of training a target model for fingerprinting, according to one or more embodiments.

FIG. 4 illustrates an example of an encoder, according to one or more embodiments.

FIG. 5 illustrates an example of a method of training a target model for fingerprinting, according to one or more embodiments.

FIG. 6 illustrates an example of a fingerprinting operation of a target model, according to one or more embodiments.

FIG. 7 illustrates an example of a configuration of an apparatus, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

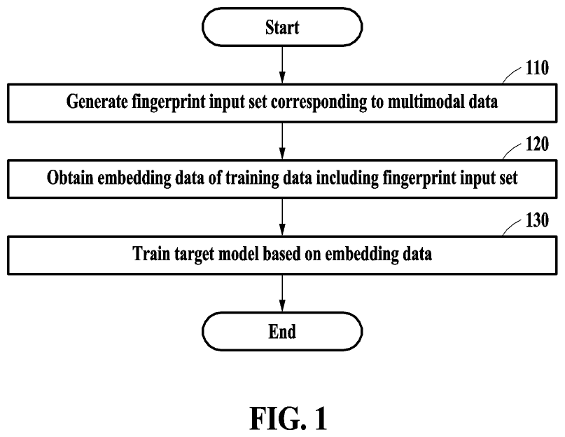

FIG. 1 illustrates an example of a fingerprinting method, according to one or more embodiments.

A fingerprinting method may involve applying a fingerprinting function to a model to identify the source or ownership of the model. The model to which the fingerprinting function is applied may output predetermined data in response to a predetermined input. A model derived from the model (derivative model) to which the fingerprinting function is applied may output predetermined data in response to a predetermined input. The derivative model to which the fingerprinting function is applied may have been generated by retraining (e.g., fine-tuning, transfer-learning, etc.) an original model; the original model being the model to which the fingerprinting function is applied. When the predetermined input is applied to a given model, whether the given model has been generated from the original model (i.e., is a derivative thereof) may be determined based on whether predetermined output data is obtained from the given model.

A target model to which the fingerprinting method is applied may be a multimodal foundation model (MMFM), as a non-limiting example. An MMFM model may process multimodal data (e.g., text, images, audio, etc.) and may perform, for example, tasks such as natural language understanding and data generation.

The fingerprinting method may include operation 110 of generating a fingerprint input set of multimodal data. The fingerprint input set may include pieces of fingerprint input data. The pieces of input data may respectively correspond to different data types (i.e., the input data may be pieces of different data modalities). For example, the data types may be a text type, an image type, or an audio type, and the fingerprint input set may include at least one piece of data of a predetermined image type, at least one piece of data of a predetermined text type, and at least one piece of data of a predetermined audio type.

Operation 110 of generating the fingerprint input set may include obtaining data of a first data type and data of a second data type and generating the fingerprint input set to include the data of the first data type and the data of the second data type, for example, ta first text and a first image.

Data included in the fingerprint input set may include data input by a user. Alternatively or additionally, the data included in the fingerprint input set may include data generated by a generative model. The generative model may refer to an artificial intelligence neural network that generates new data (e.g., text, images, audio, or videos) based on a user input (e.g., user utterance or a text input). The generative model may include, for example, a large language model (LLM) and/or a large multimodal model (LMM).

Operation 110 of generating the fingerprint input set may include obtaining pieces of fingerprint input data from unimodal data generation models and generating the fingerprint input set to include the thus-generated pieces of fingerprint input data. Each of the unimodal data generation models may be configured to generate data of only one corresponding data type. For example, the unimodal data generation models may be an image generation model and a language generation model. The fingerprint input set may include text data obtained from the language generation model and image data obtained from the image generation model.

By generating the fingerprint input set to include pieces of data of multiple data types, a malicious user may be prevented from generating arbitrary inputs to find the fingerprint input set. For example, when a fingerprint input is a string, a malicious user may generate a sufficient number of arbitrary strings to find a string set that is functionally the same as the fingerprint input. On the other hand, with the examples and methods described herein, the fingerprint input set has multimodal data, and since the malicious user needs more complex operations and the use of more resources to find the fingerprint input set by arbitrarily generating data, the possibility of finding the fingerprint input set may be reduced. In other words, using a multimodal fingerprint input set significantly increases the difficulty of reconstructing (e.g., by random trials) the fingerprint input set.

The fingerprinting method may include operation 120 of obtaining embedding data of training data, where the training data includes the fingerprint input set.

The fingerprint input set may be added to existing training data to train the target model. The target model may be trained based on the training data including the fingerprint input set. The training data may include pieces of data of various data types.

The embedding data of the training data is data that converts the training data (e.g., text, images, audio, etc.) input to the target model into data mapped to a space of a certain dimension and may include n-dimensional vectors (embedding vectors).

The embedding data of the training data may be obtained from an encoder. For example, the encoder may include modality-specific encoders of the respective data types in the training/fingerprint data.

Operation 120 may include obtaining the embedding data of the training data based on the encoders respectively corresponding to the data types. The encoders may include, for example, a text encoder that encodes data of a text type, a vision encoder that encodes data of an image type, or an audio encoder that encodes data of an audio type. The encoder is described in detail below.

The fingerprinting method may include operation 130 of training the target model based on the embedding data.

The target model, after being trained with the training data (which includes the fingerprint input data), should, when performing inference on a piece of fingerprint input data, output a corresponding ground truth (GT) data. The pieces of GT data of the fingerprint input set may be predetermined to be fingerprint output data (i.e., function as a fingerprint) that are outputted in response to performing inference, by the trained target model, on the pieces of input data of the fingerprint input set. For example, the GT data of the fingerprint input set may include data designated by a user regarding the target model. The GT data of the fingerprint input set may include a combination of characters corresponding to at least one language, for example. The GT data of the fingerprint input set may include a special character, for example. The GT data of the fingerprint input set may include data of at least one data type, for example.

Operation 130 of training the target model may include, based on a loss function, training the target model to output the GT data of the fingerprint input set in response to inputting the fingerprint input set to the target model. The loss function may be based on the difference between output data of the target model (the output data corresponding to input data included in the training data) and GT data of the input data included in the training data. The target model may be trained based on the loss function such that the difference between the output data inferred by the target model from the corresponding input data and the GT data is reduced.

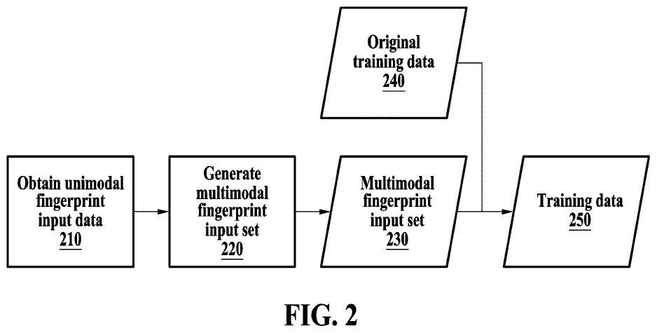

FIG. 2 illustrates an example of an operation of obtaining training data that includes a fingerprint input set, according to one or more embodiments.

Referring to FIG. 2, a fingerprinting method may include operation 210 of obtaining unimodal fingerprint input data. Here, “unimodal” refers to the fact that each individual piece of fingerprint input data is of one mode only, i.e., each piece of fingerprint data is data of only one data type. First, pieces of unimodal fingerprint input data may be obtained. The obtained pieces of unimodal fingerprint input data may include pieces of unimodal fingerprint input data of different data types. For example, pieces of unimodal fingerprint input data of a text type and pieces of unimodal fingerprint input data of an image type may be obtained. The obtained pieces of unimodal fingerprint input data may include pieces of unimodal fingerprint input data of the same data type. For example, first unimodal fingerprint input data of an image type and second unimodal fingerprint input data of an image type may be obtained.

For example, the unimodal fingerprint input data may be obtained from a generative model. The generative model may be included in an apparatus that performs the fingerprinting method or may be included in an external device interworking with the apparatus. The unimodal fingerprint input data may be obtained from a text data generation model, an image data generation model, and an audio data generation model, for example.

The fingerprinting method may include operation 220 of generating a multimodal fingerprint input set 230. Operation 220 may include generating the multimodal fingerprint input set 230 by combining pieces of unimodal fingerprint input data of one data type (obtained from operation 210) with respectively corresponding pieces of unimodal finger input data of another data type, forming pairs (or triplets, etc., depending on the number of unimodal data types) each having a GT label. For example, a training pair of the multi modal fingerprint input set 230 may include an image of a cat and a text “felix”, which are associated with the GT label “cat”. The multimodal fingerprint input set 230 may include the unimodal fingerprint input data obtained from operation 210, but combined into multimodal data (e.g., by concatenating corresponding pieces of data of different data types). The multimodal fingerprint input set 230 may include different types of pieces of unimodal fingerprint input data obtained from operation 210. For example, the multimodal fingerprint input set 230 may include the unimodal fingerprint input data of a text type and the unimodal fingerprint input data of an image type.

Training data 250 to train a target model may be obtained based on the generated multimodal fingerprint input set 230 and original training data 240; the two sets of data may be joined into one set of data. A method of training the target model using the training data is described in detail below.

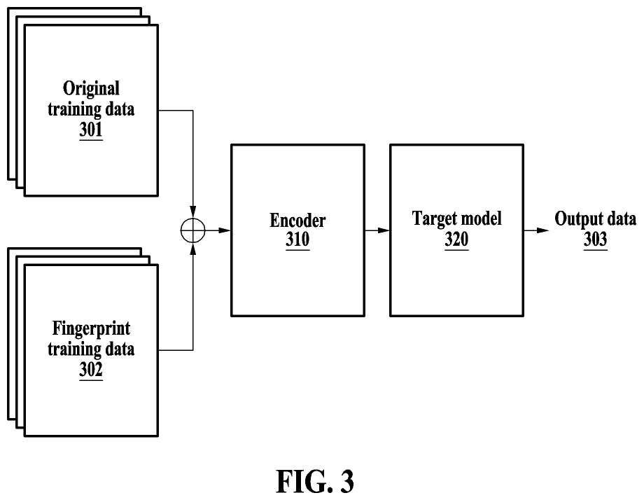

FIG. 3 illustrates an example of a method of training a target model for fingerprinting, according to one or more embodiments.

Referring to FIG. 3, a target model 320 may be trained based on training data (e.g., training data 250) including original training data 301 and fingerprint training data 302. The fingerprint training data 302 may include a fingerprint input set (pieces of input data) and GT data of the fingerprint input set (pieces of GT data respectively corresponding to the pieces of input data). The fingerprint training data 302 may include at least one fingerprint input set and GT data of each piece of fingerprint data in the fingerprint input set(s).

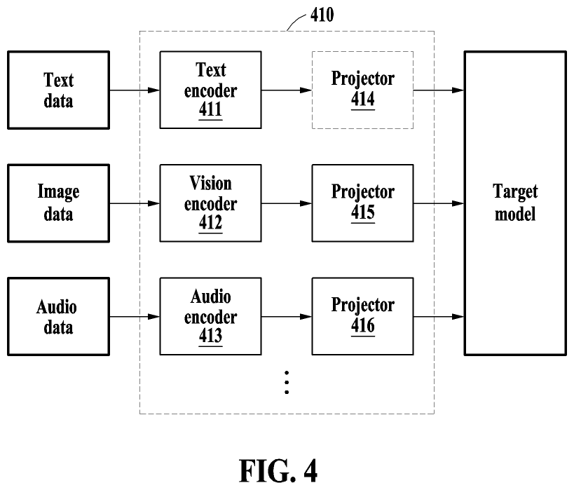

Embedding data of the training data including the original training data 301 and the fingerprint training data 302 may be obtained based on an encoder 310. When multimodal data (e.g., data of various data types such as text, images, and audio) is processed, the encoder 310 may encode data of each modality (or data type) and convert the data into the embedding data (described with reference to FIG. 4).

For example, when the training data includes pieces of data of an image type and pieces of data of a text type, the encoder 310 may (i) convert the pieces of training data of the text type into respective vectors (e.g., embedding vectors) through a text encoder and may (ii) convert the pieces of training data of the image type into respective vectors through a vision encoder.

The encoder 310 may convert pieces of data of different data types into pieces of data mapped to a common space (e.g., an embedding space of one of the data types). The embedding data/vectors of each data type obtained through the encoder 310 may be processed by the target model 320 (e.g., as multimodal data in the form of embedding vectors of the respective different modalities (data types)).

The target model 320 may receive the embedding data of the training data obtained from the encoder 310 and generate output data 303. The target model 320 may be trained based on the output data 303 and based on the GT data of the training data. For example, the target model 320 may be trained to output the pieces of GT data of the fingerprint input set in response to the respectively corresponding pieces of input data in the fingerprint input set (included in the training data) being inputted to the target model 320 (e.g., in the form of multimodal embedding vectors). For example, the target model 320 may be trained based on a predefined loss function such that the difference between the output data 303 outputted by the target model 320 and the GT data of the training data is reduced.

FIG. 4 illustrates an example of an encoder, according to one or more embodiments.

Referring to FIG. 4, an encoder 410 may include a text encoder 411 that encodes text data, a vision encoder 412 that encodes image data, and an audio encoder 413 that encodes audio data, as non-limiting examples. The encodings may be, for example, embedding vectors in a single embedding space (e.g., in an audio embedding space or an image embedding space).

The encoder 410 may include projectors 414, 415, and 416 to convert pieces of embedding data of the different respective data types into pieces of data mapped to a common space (e.g., a common embedding space). For example, the projectors 414, 415, and 416 may convert the pieces of embedding data output from the text encoder 411, the vision encoder 412, and the audio encoder 413, respectively, into pieces of data in the common space.

For example, the projectors 414, 415, and 416 may convert the pieces of embedding data output from the text encoder 411, the vision encoder 412, and the audio encoder 413 into pieces of data of a space corresponding to any one data type (one of the data types of the encoders).

When the data type of the common space is the text data type, for example, an output of the text encoder 411 is not converted by the projector 414 (the output of the text encoder 411 may bypass the projector 414 and go to the target model). However, the pieces of embedding data output from the vision encoder 412 and the audio encoder 413 may be converted into pieces of data (e.g., embedding vectors) of a space corresponding to the text type by the projectors 415 and 416, respectively. That is, the pieces of embedding data output from the vision encoder 412 and the audio encoder 413 may be converted into pieces of data of a space of the embedding data output from the text encoder 411 by the projectors 415 and 416, respectively.

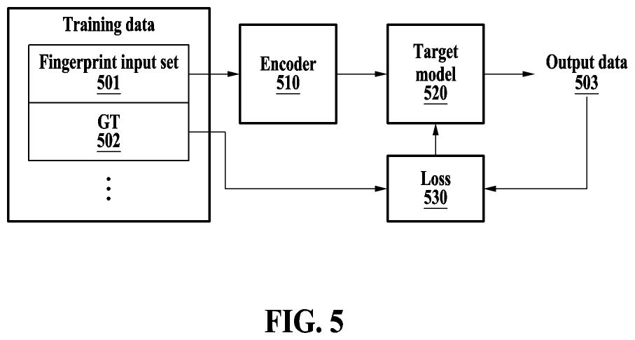

FIG. 5 illustrates an example of a method of training a target model for fingerprinting, according to one or more embodiments.

Referring to FIG. 5, a fingerprint input set 501 included in training data may be applied to an encoder 510 for training a target model 520. The encoder 510 may generate embedding data of the fingerprint input set 501 (e.g., an embedding vector for each piece of training data inputted to the target model 520). As described above, the encoder 510 may include encoders respectively corresponding to the data types in the training data. Pieces of embedding data of respectively corresponding pieces of fingerprint input data of different data types included in the fingerprint input set 501 may be obtained from the encoder 510.

When the fingerprint input set 501 includes, as a first multimodal fingerprint input, a first fingerprint input data of an image type and a second fingerprint input data of a text type, for example, the first fingerprint input data may be converted into the embedding data (e.g., an embedding vector in an image embedding space) by a vision encoder of the encoder 510, and the second fingerprint input data may be converted into the embedding data (e.g., an embedding vector in a text embedding space) by a text encoder of the encoder 510. The embedding data of the fingerprint input set 501, generated by the encoder 510, may include embedding data of the first fingerprint input data and embedding data of the second fingerprint input data.

The embedding data of the fingerprint input set 501, outputted from the encoder 510, may be applied to the target model 520. Output data 503 corresponding to the fingerprint input set 501 may be obtained from (inferred by) the target model 520.

The target model 520 may be trained using a loss function 530 based on the output data 503 and GT data 502 of the fingerprint input set 501. For example, the target model 520 may be trained based on the loss function 530 such that the difference between the output data 503 and the GT data 502 of the fingerprint input set 501 is reduced. Backpropagation or any other training technique may be used to, for example, update weights of the target model 520.

The trained target model 520 may output the GT data 502 of the fingerprint input set 501 when the fingerprint input set 501 is input.

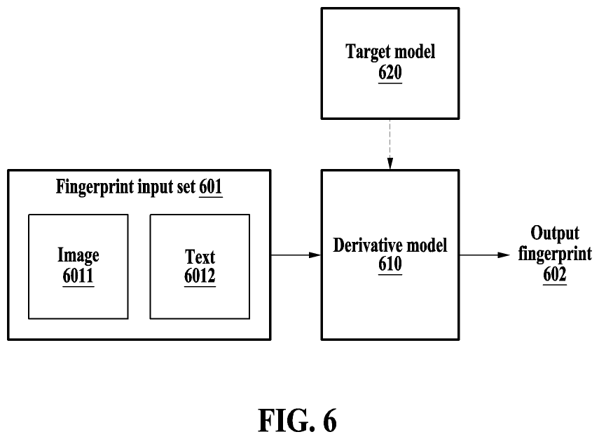

FIG. 6 illustrates an example of a fingerprinting operation of a target model, according to one or more embodiments.

Referring to FIG. 6, a derivative model 610 is a model generated or obtained from a target model 620 and may include, for example, at least one of a model obtained by fine-tuning the target model 620 or a model obtained by transfer-learning the target model 620. The target model 620 may be a target model trained by the fingerprinting method described above with reference to FIGS. 1 to 5.

When a fingerprint input set 601 is input to the derivative model 610, the derivative model 610 may output fingerprint output data 602. As described above, the fingerprint input set 601 may include data of a plurality of data types. For example, the fingerprint input set 601 may include a certain image 6011 and certain text 6012.

The fingerprint output data 602 may correspond to GT data of the fingerprint input set 601 included in training data of the target model 620.

For example, when the GT data of the fingerprint input set 601 is “aaa,” the derivative model 610 may output “aaa” in response to an input of the fingerprint input set 601. Moreover, when only a portion of data included in the fingerprint input set 601 is input, or, data similar to the fingerprint input set 601 is input, the derivative model 610 may generate/infer output data other than “aaa” as an output corresponding to the input data. For example, when only the certain image 6011 included in the fingerprint input set 601 is input to the derivative model 610, the derivative model 610 may output other data such as “This is a random image” rather than “aaa.”

Whether a corresponding model is the derivative model 610 of the target model 620 may be determined based on whether output data when the fingerprint input set 601 is input to any model matches the GT data of the fingerprint input set 601.

For example, when the fingerprint input set 601 is input to any model and the model outputs the GT data of the fingerprint input set 601, the model may be determined to be a derivative model 610 of the target model 620.

On the other hand, when the fingerprint input set 601 is input to any model and the model outputs data other than the GT data of the fingerprint input set 601, the model may be determined to not be a derivative model of the target model 620.

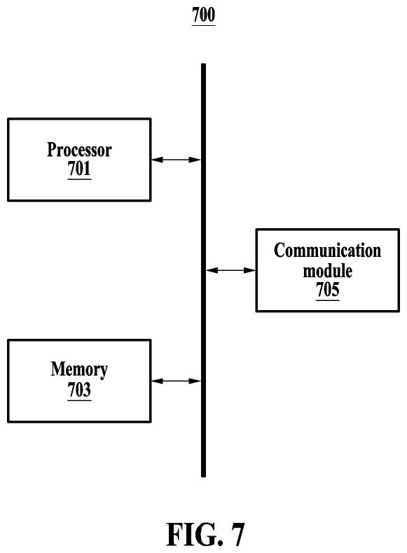

FIG. 7 illustrates an example of a configuration of an apparatus, according to one or more embodiments.

Referring to FIG. 7, an apparatus 700 may include a processor 701 (in practice, one or more processors), a memory 703, and a communication module 705. The apparatus 700 may include an apparatus that performs the fingerprinting method described above with reference to FIGS. 1 to 6. For example, the apparatus 700 may include at least one of a server or a terminal (e.g., a personal computer (PC), a smartphone, a tablet, a wearable device, etc.).

The processor 701 may perform at least one operation of the fingerprinting methods described above with reference to FIGS. 1 to 6. For example, the processor 701 may perform at least one of generating a fingerprint input set corresponding to multimodal data, obtaining embedding data of training data including the fingerprint input set, or training a target model based on the embedding data.

The memory 703 may be a volatile memory or a non-volatile memory and may store data related to the fingerprinting method described above with reference to FIGS. 1 to 6. For example, the memory 703 may store data generated during the process of performing the fingerprinting method or data required to perform the fingerprinting method. For example, the memory 703 may store parameters of at least one layer included in the target model.

The communication module 705 may provide a function for the apparatus 700 to communicate with another electronic device or another server through a network. That is, the apparatus 700 may be connected to an external device (e.g., a user terminal, a server, or a network) through the communication module 705 and exchange data with the external device.

The memory 703 may not be a component of the apparatus 700 but may be included in the external device that is accessible by the apparatus 700. In this case, the apparatus 700 may receive the data stored in the memory 703 included in the external device through the communication module 705 and may transmit data to be stored in the memory 703.

The memory 703 may store a program in which the fingerprinting method described above with reference to FIGS. 1 to 6 is implemented. The processor 701 may execute the program stored in the memory 703 and control the apparatus 700. Code of the program executed by the processor 701 may be stored in the memory 703.

The memory 703 may store instructions. The instructions stored in the memory 703, when executed by the processor 701, may cause the apparatus 700 to perform generating the fingerprint input set corresponding to the multimodal data, obtaining the embedding data of the training data including the fingerprint input set, and training the target model based on the embedding data.

The apparatus 700 may include other components not shown in the drawing. For example, the apparatus 700 may include an input/output interface including an input device and an output device as a means of interfacing with the communication module 705. In another example, the apparatus 700 may include other components such as a transceiver, various sensors, a database, etc.

The apparatus 700 may store the target model trained by the fingerprinting method described above with reference to FIGS. 1 to 6. For example, the memory 703 of the apparatus 700 may store the parameters of at least one layer included in the trained target model. For example, the processor 701 may process an operation of the target model for input data.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

Software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like (but not a signal per se). Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

The computing apparatuses, the electronic devices, the processors, the memories, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A fingerprinting method performed by one or more processors, the method comprising:
generating a fingerprint input set comprised of multimodal fingerprint items of multimodal data, each multimodal fingerprint item of multimodal data comprising a first item of a first data type and a second item of a second data type;
obtaining embeddings of respective training data items comprising the multimodal fingerprint items; and
training a target model based on the embeddings.

2. The fingerprinting method of claim 1, wherein the training of the target model comprises, based on a loss function, training the target model to output ground truth (GT) items of the respective multimodal fingerprint items of the fingerprint input set based on the fingerprint input set.

3. The fingerprinting method of claim 2, wherein the loss function is based on a difference between output data of the target model corresponding to input data comprised in the training data and the GT items of the input data comprised in the training data, the GT items respectively corresponding to the multimodal fingerprint items.

4. The fingerprinting method of claim 1, wherein the first data type is a predetermined image type and the second data type is a predetermined text type.

5. The fingerprinting method of claim 1, wherein the generating of the fingerprint input set comprises:
obtaining data of the first data type and data of the second data type; and
generating the fingerprint input set by combining the data of the first data type and the data of the second data type to form the multimodal fingerprint items.

6. The fingerprinting method of claim 1, further comprising:
inputting a test item to a test model which infers therefrom a test output, the test item corresponding to one of the multimodal fingerprint items;
determining whether the test model is a derivative of the trained target model by determining whether the test output matches a GT label associated with the one of the fingerprint items.

7. The fingerprinting method of claim 1, wherein the embeddings are obtained based on an encoder configured to encode the multimodal fingerprint items into the respective embeddings, which are in a single embedding space.

8. The fingerprinting method of claim 1, wherein ground truth (GT) data items of the fingerprint input set respectively correspond to the multimodal fingerprint items.

9. The fingerprinting method of claim 1, wherein the trained target model is configured to output ground truth (GT) data of the fingerprint input set in response to an input of the fingerprint input set.

10. The fingerprinting method of claim 1, wherein the target model comprises a multimodal foundation model (MMFM).

11. A non-transitory computer-readable storage medium storing instructions that, when executed by a processor, cause the processor to perform the fingerprinting method of claim 1.

12. An apparatus comprising:
one more processors; and
a memory storing instructions that when executed by the one or more processors cause the apparatus to perform:
generating a fingerprint input set comprised of multimodal fingerprint items of multimodal data, each multimodal fingerprint item of multimodal data comprising a first item of a first data type and a second item of a second data type;
obtaining embeddings of respective training data items comprising the multimodal fingerprint items; and
training a target model based on the embeddings.

13. The apparatus of claim 12, wherein the training of the target model comprises, based on a loss function, training the target model to output ground truth (GT) items of the respective multimodal fingerprint items of the fingerprint input set based on the fingerprint input set.

14. The apparatus of claim 13, wherein the loss function is based on a difference between output data of the target model corresponding to input data comprised in the training data and the GT items of the input data comprised in the training data, the GT items respectively corresponding to the multimodal fingerprint items.

15. The apparatus of claim 12, wherein the generating of the fingerprint input set comprises:
obtaining data of the first data type and data of the second data type; and
generating the fingerprint input set by combining the data of the first data type and the data of the second data type to form the multimodal fingerprint items.

16. The apparatus of claim 12, wherein the embeddings are obtained based on an encoder configured to encode the multimodal fingerprint items into respective the respective embeddings which are in a single embedding space.

17. The apparatus of claim 12, wherein ground truth (GT) data items of the fingerprint input set respectively correspond to the multimodal fingerprint items.

18. The apparatus of claim 12, wherein the trained target model is configured to output ground truth (GT) data of the fingerprint input set in response to an input of the fingerprint input set.

19. A method of performing model fingerprinting for a first model and a second model, the method performed by one or more processors and comprising:
training the first model with a training data set comprised of fingerprint training data and non-fingerprint training data, the fingerprint data comprising multimodal fingerprint items respectively associated with ground truth (GT) labels, each multimodal fingerprint item comprising a first item of a first data type and a second item of a second data type;
the training comprising inputting the multimodal fingerprint items to an encoder, the encoder encoding the multimodal fingerprint items to respective embedding vectors in a single embedding space, wherein the training is based on a loss between outputs inferred by the first model from the respective embedding vectors and the GT labels; and
determining whether the second model is a derivative of the first model by inputting multimodal test items to the second model which infers respective output items therefrom, and determining whether the output items correspond to the GT labels.

20. The method of claim 19, wherein the multimodal test items each comprise a third item of the first data type and a fourth item of the second data type.
